(19) United States
(12) Patent Application Publication
(10) Pub. No.: US 2014/0316922 A1
(43) Pub. Date: Oct. 23, 2014

(54) PASSBACK AUCTION

(71) Applicants: Martin Pal, Maplewood, NJ (US); Gagan Goel, New York, NY (US); Craig Helfgott, North Bergen, NJ (US); David Pal, New York, NY (US); Fedor Labounko, Brooklyn, NY (US)

(72) Inventors: Martin Pal, Maplewood, NJ (US); Gagan Goel, New York, NY (US); Craig Helfgott, North Bergen, NJ (US); David Pal, New York, NY (US); Fedor Labounko, Brooklyn, NY (US)

(73) Assignee: Google Inc., Mountain View, CA (US)

(21) Appl. No.: 13/822,484

(22) PCT Filed: Aug. 31, 2012
(86) PCT No.: PCT/UA2012/000081

§ 371 Date: Mar. 12, 2013

(51) Int. Cl. G06Q 30/08

(52) U.S. Cl. CPC G06Q 30/08
USPC 705/26.3

(57) ABSTRACT

Methods, systems, and apparatus, including computer programs encoded on a computer storage medium, for allocating content. In one aspect, a method includes identifying bids for a plurality of eligible bidders that are eligible to provide a content item in response to a content item request. From among the eligible bidders, a set of passback bidders having a passback capability are identified. The passback capability provides passback bidders an option refuse to provide a content item. From among the bidders, a set of general bidders, for which the passback capability is not enabled, are identified. A bidder chain that includes a highest general bidder and passback bidders is generated. A highest bidder in the bidder chain that does not refuse to provide a content item after being identified as the winning bidder is selected as the final bidder.

### BACKGROUND

This specification relates to data processing and auctions.

The Internet provides access to a wide variety of resources. For example, video and/or audio files, as well as web pages for particular subjects or that present particular news articles are accessible over the Internet. Access to these resources presents opportunities for advertisements (or other sponsored content items) to be provided with the resources. For example, a web page can include “slots” (i.e., specified portions of the web page) in which advertisements (or other content items) can be presented. These slots can be defined in the web page or defined for presentation with a web page, for example, in a separate browser window. Advertisements or other content items that are presented in slots of a resource are selected for presentation by a content distribution system that can perform an auction as part of the selection process.

### SUMMARY

In general, one innovative aspect of the subject matter described in this specification can be embodied in methods that include the actions of receiving a content item request; identifying, by a data processing apparatus, bids for a plurality of eligible bidders that are eligible to provide a content item in response to the content item request; identifying, among the eligible bidders, a set of passback bidders for which a passback capability is enabled, wherein the passback capability provides passback bidders an option refuse to provide a content item after selection of a winning bidder; identifying, among the bidders, a set of general bidders for which the passback capability is not enabled; creating, by a data processing apparatus, a bidder chain that includes a highest general bidder and one or more passback bidders having higher bids than the highest general bidder, each bidder being assigned a position in the bidder chain based on their respective bids; and selecting, from the bidder chain and by a data processing apparatus, a final bidder that will provide a content item in response to the content item request, the final bidder being a highest bidder in the bidder chain that does not refuse to provide a content item after being identified as the winning bidder. Other embodiments of this aspect include corresponding systems, apparatus, and computer programs, configured to perform the actions of the methods, encoded on computer storage devices.

These and other embodiments can each optionally include one or more of the following features. Creating the bidder chain can include selecting, as a lowest bidder in the bidder chain, the highest general bidder; ranking the set of passback bidders based on the bids for the passback bidders; identifying a first passback bidder having a next highest bid relative to the highest general bidder; and assigning the first passback bidder a next highest position in the bidder chain, the next highest position being identified relative to a position of the highest general bidder in the bidder chain.

Creating a bidder chain can include identifying a pre-specified chain length for the bidder chain, the pre-specified chain length indicating a number of bidders to be included in the chain; determining that the pre-specified chain length will be exceeded by including, in the bidder chain, all of the passback bidders having a bid higher than the highest general bidder; creating a first candidate bidder chain that includes the highest general bidder and a first passback bidder having a next highest bid relative to the highest general bidder; creating a second candidate bidder chain that includes the highest general bidder and a second passback bidder having a bid higher than the first passback bidder, but does not include the first passback bidder; and selecting the bidder chain from among the first candidate bidder chain and the second candidate bidder chain.

Selecting the bidder chain can include identifying fill rates for the passback bidders, the fill rate for each passback bidder specifying a rate with which the passback bidder has refused to provide a content item after being selected as the winning bidder; determining a chain value for the first candidate bidder chain, the chain value being determined based on the bids for bidders in the first candidate bidder chain and the fill rate for each passback bidder in the first candidate bidder chain; determining the chain value for the second candidate bidder chain, the chain value for the second candidate bidder chain being determined based on the bids for bidders in the second candidate bidder chain and the fill rate for each passback bidder in the second candidate bidder chain; and selecting one of the first candidate bidder chain or the second candidate bidder chain as the bidder chain, the selected bidder chain having a highest chain value.

Methods can further include determining a price for the final bidder, the determination including: removing the final bidder from the bidder chain, to create a modified chain; determining a first chain value for the modified chain, the first chain value being determined based on the bids for bidders in the modified chain and the fill rate for each passback bidder in the modified chain; identifying an alternative chain that includes a different set of bidders than the modified chain and does not include the final bidder; determining a second chain value for the alternative chain, the second chain value being determined based on the bids for bidders in the alternative chain and the fill rate for each passback bidder in the alternate bidder chain; and determining the price based on a difference between the first chain value and the second chain value.

Methods can further include determining a price for the final bidder, the determination including: removing the final bidder from the bidder chain to create a first alternative chain; determining a first chain value for the first alternative chain, the first chain value being determined based on the bids for bidders in the first alternative chain and the fill rate for each passback bidder in the first candidate bidder chain; identifying a reserve price that must be paid for providing a content item in response to the content item request; and determining the price based on a difference between the first chain value and the reserve price.

Particular embodiments of the subject matter described in this specification can be implemented so as to realize one or more of the following advantages. A content item provider that will provide a content item in response to a content item request can be identified within a known period of time, even when some of the content item providers are allowed to refuse to provide a content item. Passback bidders and general bidders can compete in a same auction.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content items are distributed by a content distribution system.

FIG. 2 is a block diagram of an example data flow for performing a passback auction.

FIG. 3 is a flow chart of an example process for selecting a final bidder from a bidder chain.

FIG. 4 is a flow chart of an example process for creating a bidder chain.

FIG. 5 is a flow chart of an example process for determining a price paid by a bidder in a passback auction.

Like reference numbers and designations in the various drawings indicate like elements.

### DETAILED DESCRIPTION

A content distribution system selects a final bidder to provide a content item (e.g., an advertisement) in response to a content item request. The final bidder is selected from a list of bidders, which is referred to as a bidder chain. The bidder chain includes at least one general bidder and can include one or more passback bidders. A passback bidder is a bidder that is provided an option (e.g., by way of a passback capability) to refuse to provide a content item when selected as the winning bidder. That is, when the passback bidder is selected as the winning bidder, the passback bidder can “pass” on, decline, or otherwise indicate that the bidder will not be accepting the opportunity to provide a content item in response to the request. When the passback bidder refuses to provide a content item when selected as the winning bidder, the content distribution system selects a new winning bidder (e.g., a bidder in a next highest position of the bidder chain) and requests that the new winning bidder provide a content item in response to the content item request.

A bidder to which the content item distribution system does not provide the option to refuse to provide a content item in response to being selected as the winning bidder (e.g., does not provide the passback capability) is referred to as a general bidder. That is, once a general bidder is selected as the winning bidder, the content distribution system does not allow the general bidder to “pass” on the opportunity to provide a content item.

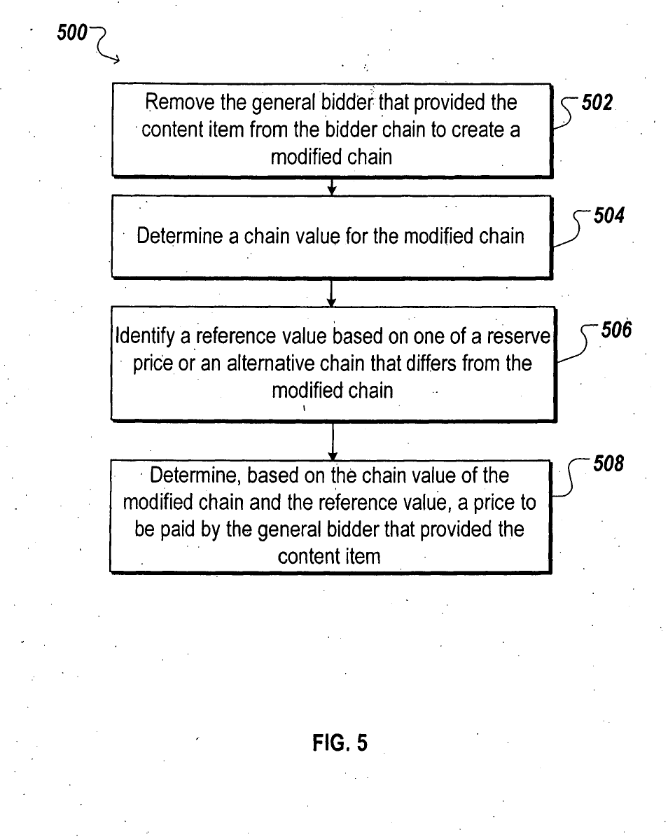

The bidder chain generally specifies the order in which bidders will be offered the opportunity to provide a content item in response to the content item request. For example, the first bidder that is offered the opportunity to provide a content item (e.g., by being selected as the winning bidder) will be the bidder that occupies a highest position in the bidder chain. When the bidder in the highest position is a passback bidder and refuses to provide a content item in response to the request, the bidder occupying the next highest position in the bidder chain will be selected as the winning bidder, and therefore, have the opportunity to provide a content item in response to the request. If subsequent winning bidders continue to be passback bidders that refuse to provide a content item, the content distribution system can continue to select, as the winning bidder, the bidder occupying the next highest position in the bidder chain until the selected winning bidder is either a passback bidder that provides a content item or a general bidder. Once a final winning bidder (i.e., a winning bidder that provides a content item) is identified, a price to be paid by the final winning bidder is selected, as described below with reference to FIG. 5.

In some implementations, the content distribution system creates the bidder chain in a manner such that a general bidder is required to be the last bidder in the bidder chain. For example, the content distribution system can select a highest general bidder as the last bidder in the bidder chain, and select one or more passback bidders to occupy higher positions in the bidder chain. The passback bidders that are selected to occupy the higher positions of the bidder chain will generally have bids that are higher than the bid for the highest general bidder. By creating the bidder chain in this manner, at least one bidder in the bidder chain is obligated to provide a content item request, while higher bidding passback bidders (i.e., relative to the bid provided by the highest general bidder) are offered an opportunity to provide a content item.

The description that follows describes the content distribution system as an advertisement distribution system that distributes advertisements for two or more different advertising networks (i.e., content item providers that provide advertisements). The apparatus and methods discussed below can also be used to facilitate selection and delivery of other content items in response to content requests. Additionally, the operations described below can be performed for individual advertisers instead of, or in addition to, advertising networks.

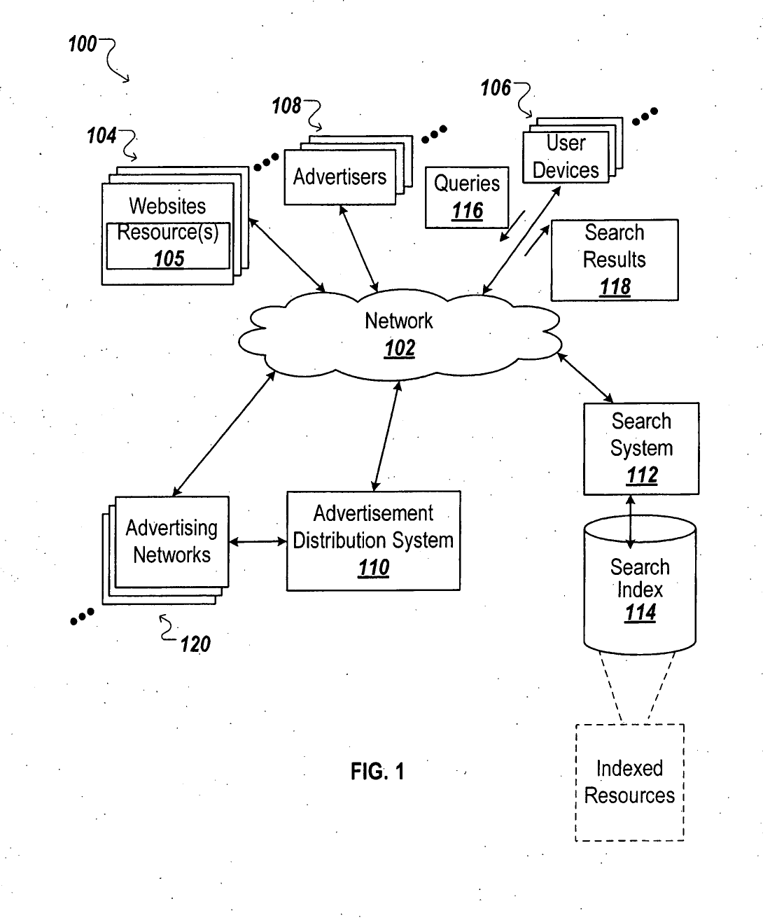

FIG. 1 is a block diagram of an example environment 100 in which content items are distributed by a content distribution system. For example, the environment 100 includes an advertisement distribution system 110 that manages advertising services. The example environment 100 also includes a network 102, such as a local area network (LAN), a wide area network (WAN), the Internet, or a combination thereof. The network 102 connects websites 104, user devices 106, advertisers 108, and the advertisement distribution system 110. The example environment 100 may include many thousands of websites 104, user devices 106, and advertisers 108.

A website 104 is one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is an entity that controls, manages and/or owns the website 104.

A resource 105 is any data provided over the network 102. A resource 105 is identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as scripts).

A user device 106 is an electronic device that is under control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display (e.g., a presentation location of a pop-up window or in a specified area of a web page) in which advertisements can be presented. These specified portions of the resource or user display are referred to as content item slots or advertisement slots.

To facilitate searching of these resources 105, the environment 100 can include a search system 112 that identifies the resources 105 by crawling and indexing the resources 105 provided by the publishers on the websites 104. Data about the resources can be indexed based on the resource 105 to which the data corresponds. The indexed and, optionally, cached copies of the resources 105 are stored in a search index 114.

User devices 106 can submit search queries 116 to the search system 112 over the network 102. In response, the search system 112 accesses the search index 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. An example search result 118 can include a web page title, a snippet of text or a portion of an image extracted from the web page, and the URL of the web page. Search results pages can also include one or more advertisement slots in which advertisements can be presented.

When a resource 105 or search results 118 are requested by a user device 106, the advertisement distribution system 110 receives a request (i.e., a content request) for advertisements to be provided with the resource 105 or search results 118. The request for advertisements can include characteristics of the advertisement slots that are defined for the requested resource or search results page, and can be provided to the advertisement distribution system 110. For example, a reference (e.g., URL) to the resource (e.g., a retailer's web page or a web page for a sports network) for which the advertisement slot is defined, a size of the advertisement slot, and/or media types that are available for presentation in the advertisement slot can be provided to the advertisement distribution system 110. Similarly, keywords associated with a requested resource (“resource keywords”) or a search query 116 for which search results are requested can also be provided to the advertisement distribution system 110 to facilitate identification of advertisements that are relevant to the resource or search query 116.

The advertisement distribution system 110 is configured to interact with two or more advertising networks 120 (and/or other advertisement sources) that can provide advertisements in response to a content request. As described in more detail below, the advertisement distribution system 110 can select, from among the advertising networks 120, one or more advertising networks that will sequentially be offered the opportunity to provide an advertisement (or another content item) in response to an advertisement request (or another content item request). For example, upon receipt of an advertisement request, the advertisement distribution system 110 can select a chain of advertisement networks that will be sequentially contacted until one of the advertising networks 120 indicates that it will provide an advertisement in response to the advertisement request.

In some implementations, when the advertisement management system 110 contacts each advertising network 120, the advertisement management system 110 will provide information about the advertisement request and requests that the advertising network 120 identify an advertisement to be provided in response to the advertisement request. The information provided to the advertising networks can include information such as resource keywords for the resource with which the selected advertisement will be provided, demographic and/or psychographic information about the user to whom the advertisement will be presented, and/or characteristics of the advertisement slot in which the advertisement will be provided.

Based on the information included in the bid request, the advertising network 120 can select an advertisement that is eligible to be provided in response to the request (“eligible advertisements”). Eligible advertisements can include, for example, advertisements having characteristics matching the characteristics of advertisement slots and that are identified as relevant to specified resource keywords or search queries 116. In some implementations, advertisements having distribution parameters (e.g., advertiser specified keywords) that match the resource keywords or the search query 116 are selected as eligible advertisements for the advertisement request.

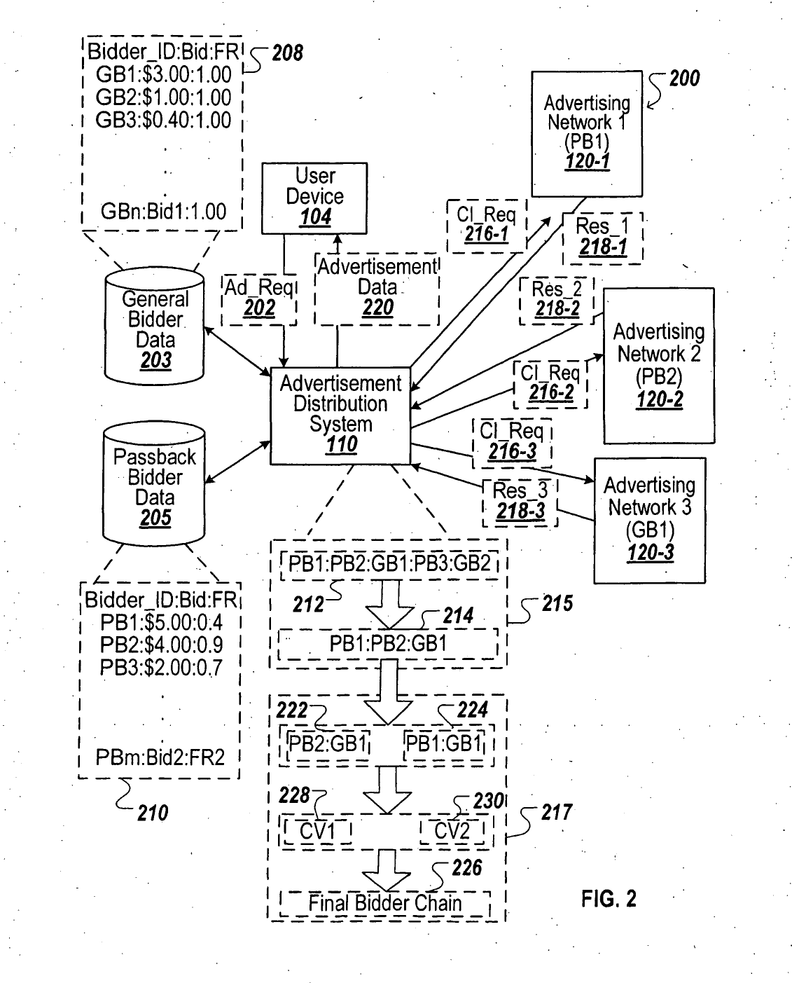

As described in detail with reference to FIG. 2, the advertisement distribution system 110 can select the advertising networks 120 that may be contacted, and the order in which they will be contacted, based on bids associated with the advertising networks 120. The bids for the advertising networks can be values that the advertising networks have specified that they will pay for each presentation of an advertisement or the bids can be determined based on historical data indicative of prices that have been previously paid by the advertising networks. When the advertisement management system 110 contacts an advertising network 120 and requests that the advertising network 120 provide an advertisement for presentation to a user device, the advertising network 120 is referred to as a winning bidder.

Some of the advertising networks 120 may be “passback bidders”, while others of the advertising networks may be “general bidders”. As noted above, passback bidders are provide a passback capability that provides the passback bidder an option to not provide an advertisement when the passback bidder is selected as the winning bidder. In contrast, general bidders are not provided the passback capability, and therefore, agree to provide an advertisement each time that the general bidder is selected as the winning bidder. Because some of the advertising networks 120 are passback bidders, the process by which the advertising networks are selected to be contacted is referred to as a passback auction. The selection of advertising networks to contact in a passback auction, and the order in which the advertising networks are contacted is selected to increase the likelihood that an advertisement is provided to a requesting user device within a threshold period of time after receipt of the request from the user device.

FIG. 2 is a block diagram of an example data flow 200 for performing a passback auction. The data flow begins with receipt of an advertisement request (“Ad_Req”) 202 (or another content item request) from a user device. Note that the advertisement request is considered to be received from the user device to which the advertisement will be provided even if the advertisement request is not received directly from that user device. For example, one or more servers may handle the advertisement request prior to receipt of the advertisement request.

In response to receipt of the advertisement request 202, the advertisement distribution system 110 can obtain bid data from one or more of a general bidder data store 204 and/or a passback bidder data store 206. The general bidder data store 204 stores bid data 208 for a set of general bidders (e.g., GB1-GBn). The passback bidder data store 206 stores bid data 210 for a set of passback bidders (e.g., PB1-PBm).

The bid data 208 for the general bidders and the bid data 210 for passback bidders each include a bid for each of the bidders. The bid for each bidder specifies a maximum amount that the bidder will pay for distribution of a content item, such as an advertisement. For example, if an advertiser specifies a bid of $1.00, this bid indicates that the advertiser will pay up to $1.00 for presentation of an advertisement. Bids can be expressed on a cost-per-click (CPC) basis, cost-per-mille (CPM) basis, or based on some other action (e.g., cost-per-conversion) or another distribution metric.

In some implementations, the bid data also includes fill rate data indicative of a fill rate for each of the bidders. The fill rate is a rate with which a bidder has provided a content item after being selected as the winning bidder. In some implementations, the fill rate for a bidder can be computed as a ratio of a number of content item requests for which the bidder provided a content item in response to content item requests relative to a total number of content item requests for which the bidder was selected as a winning bidder.

For example, assume that Advertiser X is a passback bidder and has been previously selected as the winning bidder for 100 advertisement requests. Further assume that for 20 of the 100 advertisement requests, Advertiser X has “passed” on the opportunity to provide an advertisement in response to the advertisement request, for example, by refusing the provide an advertisement in response to the advertisement request. In this example, Advertiser X has provided advertisements in response to 80 of the 100 advertisement requests for which Advertiser X was selected as the winning bidder, such that the fill rate for Advertiser X is 0.80 (i.e., 0.80=80 advertisement requests fulfilled by Advertiser X/100 selections of Advertiser X as a winning bidder). Since general bidders are not enabled to refuse to provide a content item in response to a content item request, general bidders are considered to have a fill rate of 1.0, indicating that they will provide a content item each time they are selected as the winning bidder. Note that the fill rate of 1.0 for the general bidders can be specified either numerically or with other data, such as a data flag that identifies the general bidder as such.

Using the bid data, the content item distribution system 110 selects a set of eligible bidders 212 for the advertisement request 202. In some implementations, the advertisement distribution system 110 selects, as the set of eligible bidders 212, the N highest bidders (i.e., the N bidders having the highest bids), where N is an integer. For example, if N is set to 5, the advertisements management system 110 would select, as the set of eligible bidders 212, bidders PB1, PB2, GB1, PB3, and GB2, since these bidders are associated with the five highest bids among the bidders.

In some implementations, the advertisement distribution system 110 selects the eligible bidders 212 based, at least in part, on a reserve price that is associated with the advertisement request 202. For example, assume that the advertisement request 202 includes data indicating that the winning bidder for the advertisement request 202 must have a bid of at least $0.50. Thus, the advertisement distribution system 110 can select, as eligible bidders, each bidder having a bid that is $0.50 or greater. In this example, the bidder GB3 has a bid of $0.40, so bidder GB3 will not be selected for inclusion in the set of eligible bidders 212 for the advertisement request 202.

In addition to, or instead of, using the bids to select the eligible bidders, the advertisement distribution system 110 can select, as the set of eligible bidders, bidders having content items having distribution parameters that match one or more attributes of the advertisement request 202. For example, if the advertisement request includes data specifying a search query that was submitted by the user device 104, the advertisement distribution system 110 can select, as the set of eligible bidders 212, bidders for which one or more advertisements are associated with a keyword that matches the search query. Other distribution parameters, such as specified time periods during which a content item is eligible for distribution or demographic based distribution parameters can also be used to select the set of eligible bidders 212.

The advertisement distribution system 110 creates a bidder chain 214 based on the set of eligible bidders 212. In some implementations, the bidder chain 214 is created to include a highest general bidder and one or more passback bidders having a bid higher than the bid for the highest general bidder. For example, the advertisement distribution system 110 can determine, based on the general bid data, that bidder GB1 is the highest general bidder since GB1's bid of $3.00 is higher than the bids for the other general bidders (e.g., GB2 and GB3). In turn, the advertisement distribution system 110 can select passback bidders PB1 and PB2 for inclusion in the bidder chain, since these bidders each have a bid that is greater than $3.00 (i.e., PB1 has a bid of $5.00 and PB2 has a bid of $4.00).

In some implementations, the position in the bidder chain to which each bidder is assigned is based on the bids for the bidders. For example, the advertisement distribution system 110 can assign PB1 to a first (i.e., a highest) position in the bidder chain 214, since PB1's bid of $5.00 is higher than the bids for the other bidders (i.e., PB2 and GB1) that have been selected for inclusion in the bidder chain 214. The advertisement distribution system 110 can also assign PB2 to a second position (i.e., a next highest position relative to the position of PB1) in the bidder chain 214, since PB2's bid of $4.00 is higher than the $3.00 bid for GB1. GB1 can be assigned the third position (i.e., a next highest position relative to the position of PB2) in the bidder chain 214, since GB1's bid of $3.00 is lower than the bids for PB1 and PB2.

In some implementations, a maximum chain length is pre-specified for one or more bidder chains. The maximum chain length can be specified, for example, by an administrator of the advertisement management system 110. The maximum chain length may be selected, for example, based on a function of a maximum latency for providing an advertisement (or another content item) following receipt of the advertisement request 202 (or another content item request) and a maximum response period within which each passback bidder must identify an advertisement to be provided or indicate that they will not be providing an advertisement in response to the advertisement request 202. For example, if the maximum latency for providing an advertisement is 100 ms, and the maximum response period for each bidder is 30 ms, the maximum chain length can be set to 3 or fewer bidders, so that the response period for the bidders does not exceed the maximum latency for providing the advertisement. Note that the values specified above are provided for purposes of example only, and actual values used can vary.

If the number of bidders in the bidder chain 214 does not exceed the maximum chain length (or a maximum chain length has not been specified), then the bidder chain 214 can be used to select a final bidder that will provide an advertisement in response to the advertisement request 202. Thus, the operations inside of dashed line 215 can be used to identify the final bidder chain that will be used to select a final winning bidder.

The advertisement distribution system 110 can select the final bidder by sequentially contacting the bidders in the bidder chain 214, based on their position in the bidder chain 214. For example, the advertisement distribution system 110 can first send a content item request 216-1 to advertising network 1 120-1, which is the passback bidder PB1. The content item request 216-1 can include data specifying that advertising network 1 120-1 has been selected as the winning bidder for the advertisement request 202, and request that advertising network 1 120-1 identify an advertisement (or another content item) to be provided in response to the advertisement request 202.

In response to the content item request 216-1, advertising network 1 120-1 can submit response data 218-1 (Res_{—}1). The response data 218-1 can identify an advertisement that advertising network 1 120-1 will provide in response to the advertisement request 202. If the response data 218-1 identifies an advertisement that will be provided by advertising network 120-1, the advertisement distribution system can identify advertising network 1 120-1 as the final winning bidder, and provide advertisement data 220 for the user device. The advertisement data 220 can include the advertisement identified in the response data 218-1, or include data specifying a location (e.g., a URL identifying a location at which the advertisement is stored) from which the user device 104 can retrieve the advertisement identified in the response data 218-1.

Since advertising network 1 120-1 is a passback bidder, the response data 218-1 can alternatively indicate that advertising network 1 120-1 will not be providing an advertisement in response to the request, rather than identifying an advertisement that will be provided in response to the request. In response to determining that the response data 218-1 indicates that advertising network 1 120-1 will not be providing an advertisement in response to the advertisement request 202, the advertisement distribution system 110 can identify a bidder in the next highest position of the bidder chain 214 as the new winning bidder and send a content item request to the new winning bidder.

For example, in response to determining that advertising network 1 120-1 will not be providing an advertisement, the advertisement distribution system 110 will send content item request 216-2 to advertising network 2 120-2, which is the passback bidder PB2. The content item request 216-2 can identify advertising network 2 120-2 as the winning bidder, and request that advertising network 2 120-2 identify an advertisement to be provided in response to the advertisement request 202. Advertising network 2 120-2 can respond to the content item request 216-2 with response data 218-2. Like advertising network 1 120-1, advertising network 2 120-2 is also a passback bidder, the response data 218-2 can either identify an advertisement that advertising network 2 120-2 will provide in response to the advertisement request, or specify that advertising network 2 120-2 will not be providing an advertisement (or another content item) in response to the advertising request 202. If the response data 218-2 identifies an advertisement to be provided in response to the advertisement request, the advertisement distribution system 110 can identify advertising network 2 120-2 as the final winning bidder, and can provide advertisement data 220 to the user device 104 identifying the advertisement, as discussed above.

If the response data 218-2 indicates that advertising network 2 120-2 will not be providing an advertisement, the advertising network can then send a content item request 216-3 to advertising network 3, which is the general bidder (GB1) that occupies the next highest, position of the bidder chain (i.e., relative to the position occupied by PB2). The content item request 216-3 can identify advertising network 3 120-3 as the winning bidder and request that advertising network 120-3 provide an advertisement in response to the advertisement request 202. Since advertising network 3 120-3 is a general bidder, and therefore not enabled to refuse to provide an advertisement when selected as the winning bidder, response data 218-3 that is received from advertising network 3 120-3 will specify an advertisement to be provided in response to the advertisement request 202. In turn, the advertisement distribution system 110 will provide advertisement data 220 to the user device identifying the advertisement, as discussed above.

In some implementations, selection of the final bidder can be performed by the user device 106. For example, once the advertisement distribution system 110 has selected the bidder chain 214 or the final bidder chain 226, the advertisement distribution system 110 can provide the user device with chain data specifying the bidders in the bidder chain 214 or final bidder chain 226. The user device 106 can use the chain data to sequentially send the content item requests 216-1-216-3 to the advertising networks 120-1-120-3, in a manner similar to that described above. When the user device 106 receives response data (e.g., Res_{—}3 218-3) indicating that an advertising network (e.g., Advertising Network 3 120-3) will provide an advertisement in response to the advertisement request, the user device can identify that advertisement network (e.g., Advertising Network 3 120-3) as the final bidder, and report the identity of the final bidder to the advertisement distribution system 110.

As discussed above, the maximum chain length limits a number of bidders that are included in the bidder chain that is used to select a final winning bidder. When the number of bidders in the bidder chain 214 is greater than the maximum chain length, the advertisement management system can perform operations similar to those included in the dashed box 217 to create candidate bidder chains that do not exceed the maximum chain length.

For example, assume that the maximum chain length has been set to two bidders. In this example, the bidder chain 214, which includes 3 bidders (i.e., PB1, PB2, and GB1), exceeds the maximum chain length. Therefore, bidders PB1, PB2, and GB1 will be used to create different bidder chains having a length no greater than two bidders, and one of these different bidder chains will be selected as the final bidder chain from which a final bidder will be selected to provide an advertisement in response to the advertisement request 202.

As noted above; each bid chain that is used to select a final bidder can be required to include one general bidder (or another non-passback bidder), such that at least one bidder in each bidder chain will provide a content item in response to a content item request. Therefore, when the advertisement management system 110 creates candidate bidder chains using the bidders from bidder chain 214, each candidate bidder chain can be required to include a general bidder, for example, as the last bidder in each of the bidder chains.

In some implementations, fill rates can be considered when selecting bidders. Recall from the discussion above, that bidder chain includes bidders PB1, PB2, and GB1. Table 1 provides the bids and fill rates that are stored in the general bidder data store 204 and the passback bidder data store 206 for the bidders.

TABLE 1

| Bidder | Bid | Fill Rate |
|---|---|---|
| PB1 | $5.00 | 0.4 |
| PB2 | $4.00 | 0.9 |
| GB1 | $3.00 | 1.0 |

Assuming that the maximum chain length has been specified to be two bidders, and that each candidate bidder chain is required to include, as the last bidder in the chain, a general bidder, one candidate bidder chain 222 can include bidder PB2 and bidder GB1, while a second bidder chain 224 can include bidder PB1 and bidder GB1. Table 2 and Table 3 below represent candidate bidder chains that can be created using the bidders in bidder chain 214.

TABLE 2

| Bidder | Bid | Fill Rate |
|---|---|---|
| PB2 | $4.00 | 0.9 |
| GB1 | $3.00 | 1.0 |

TABLE 3

| Bidder | Bid | Fill Rate |
|---|---|---|
| PB1 | $5.00 | 0.4 |
| GB1 | $3.00 | 1.0 |

As indicated by Table 2, one of the candidate bidder chains (candidate chain 222) includes GB1 as the last bidder in the chain, while the other position in the chain is assigned to PB2, which is the next highest bidder relative to bidder GB1.

As indicated by Table 3, another candidate bidder chain (candidate chain 224) can again include GB1 as the last bidder in the bidder chain. However, in the bidder chain represented by Table 3, PB1, which is the highest bidder among bidders PB1, PB2, and GB1, is assigned to the other position in the bidder chain rather than PB2.

Once the candidate chains 222 and 224 have been created, the advertisement distribution system 110 will select the candidate bidder chain having a highest chain value as the final bidder chain 226. As used throughout this document, a chain value is a value determined based on the bids and fill rates of the bidders in the chain for which the chain value is being determined. For example, the chain value 228 for the candidate bidder chain 222 (the candidate bidder chain represented by Table 2) will be based on the bids and fill rates for bidders PB2 and GB1, while the chain value 230 for the candidate bidder chain 224 (the candidate bidder chain represented by Table 3) will be based on the bids and fill rates for bidders PB1 and GB1. In some implementations, the chain values for bidder chains can be computed using relationship (1).

$${V}_{chain} = {\sum }_{i = 1}^{n} {bid}_{{b}_{i}} * {l}_{i} ( 1 )$$

where:

V_{chain} is the chain value for the bidder chain;

bᵢ is the i^{th} bidder in the bidder chain;

n is the number of bidders in the chain; and

lᵢ the likelihood that bidder (i) is selected as the winning bidder and provides an advertisement in response to the advertisement request.

In some implementations, the lᵢ for a bidder in the first position of the bidder chain (e.g., b₁) will be the fill rate for that bidder (e.g., fill rate for b₁), and the lᵢ for each bidder that is not in the first position (e.g., b_{i>1}) can be determined using relationship (2).

l_{i>1}=(1−FRbᵢ₋₁)*FRbᵢ (2)

where:

FRbᵢ is the fill rate of bidder (i); and

FRbᵢ₋₁ is the fill rate for the bidder (i−1) in the next highest position relative to the position of bidder (i).

Using relationship (1) and relationship (2), the chain value for the candidate chain 228 (represented by Table 2) will be $3.90, the computation of which is indicated by Table 4.

TABLE 4

| Bidder | Bid | Fill Rate | lᵢ | Value = Bid*lᵢ |
|---|---|---|---|---|
| PB2 | $4.00 | 0.9 | 0.9 | $3.60 |
| GB1 | $3.00 | 1.0 | 1.0*(1.0-0.9) | $0.30 |

According to Table 4, the likelihood (lᵢ) that bidder PB2 will provide an advertisement in response to the advertisement request is 0.9, which is equal to the fill rate for bidder PB2 since bidder PB2 is the first bidder in the chain, and the value of bidder PB2 in this bidder chain is $3.60. According to Table 4, the likelihood (lᵢ) that bidder GB1 will provide an advertisement in response to the advertisement request is 0.1, which according to relationship (2) is the product of the fill rate for bidder GB1 and the likelihood that bidder PB2 does not provide an advertisement in response to the advertisement request 202 (i.e., 1.0-fill rate for bidder PB2). The likelihood that bidder PB2 does not provide an advertisement in response to the advertisement request can also be indicative of a likelihood that bidder GB1 will be selected as the winning bidder. According to relationship (1), the values in Table 4 result in a chain value of $3.90 for this candidate bidder chain.

The chain value 230 for the candidate chain 224 (represented by Table 3) can be computed using relationship (1) and relationship (2) in a similar manner as described above. For example, according to Table 5, the value of PB1 to this bidder chain is $2.00 based on the bid for bidder PB1 and the likelihood that PB1 will provide an advertisement in response to the advertisement request 202. The value of GB1 to this bidder chain is $1.80 based on the bid for bidder GB1 and a product of the fill rate for GB1 and the likelihood that bidder PB1 refuses to provide an advertisement in response to the advertisement request 202. Thus, the chain value for this bidder chain is $3.80 (i.e., $2.00+$1.80).

TABLE 5

| Bidder | Bid | Fill Rate | lᵢ | Value = Bid*lᵢ |
|---|---|---|---|---|
| PB1 | $5.00 | 0.4 | 0.4 | $2.00 |
| GB1 | $3.00 | 1.0 | 1.0*(1.0-0.4) | $1.80 |

TABLE 6

| Candidate Bidder Chain | Chain Value |
|---|---|
| Candidate Bidder Chain 222 (PB2-GB1) | $3.90 |
| Candidate Bidder Chain 224(PB1-GB1) | $3.80 |

Table 6 lists each candidate bidder chain and the respective chain values for the candidate bidder chains. According to Table 6, the candidate bidder chain including bidder GB1 and bidder PB2 has a higher chain value than the candidate bidder chain including bidder GB1 and bidder PB1. Thus, in this example, the advertisement management system 110 can select the candidate bidder chain including bidder GB1 and PB2 as the final bidder chain 226. In turn, the advertisement management system 1110 can use the final bidder chain 226 to select a final bidder to provide an advertisement in response to the advertisement request 202. The final bidder can be selected in a manner similar to that described above with reference to using the bidder chain 214 to select the final bidder. That is, the advertisement system can sequentially send content item requests to the bidders in the bid chain until a bidder that will provide an advertisement is reached.

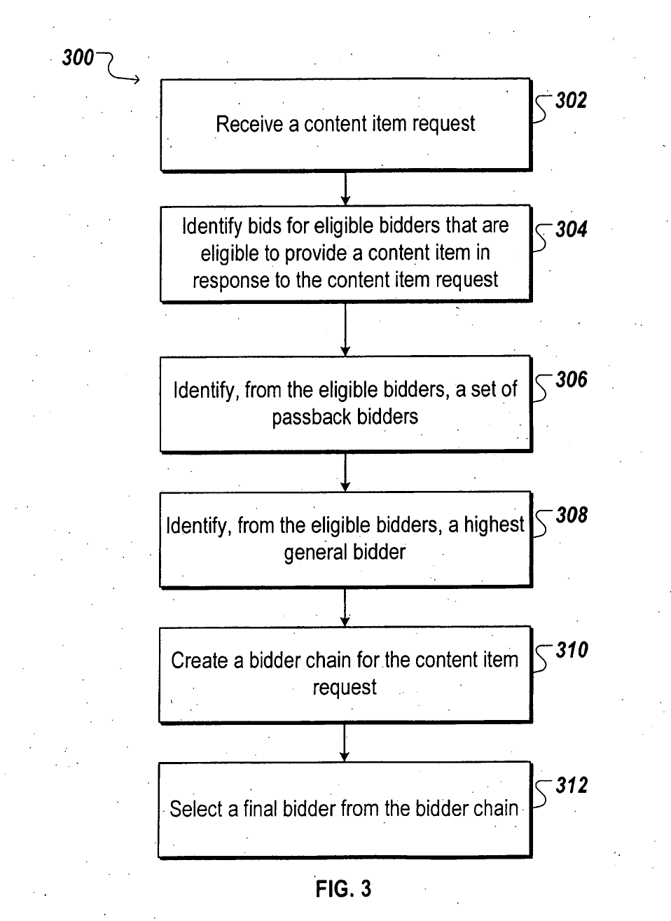

FIG. 3 is a flow chart of an example process 300 for selecting a final bidder from a bidder chain. The process 300 can be implemented, for example, using the advertising management system 110 of FIG. 1, or another data processing apparatus. The process 300 can also be implemented as instructions stored on computer storage medium such that execution of the instructions by data processing apparatus cause the data processing apparatus to perform the operations of the process 300.

A content item request is received (302). The content item request can include attributes that facilitate selection of a content item that is provided in response to the request. For example, the content item request can specify a search query that was submitted by the user device to which the content item will be provided, resource keywords for a resource with which the content item will be presented, demographic information for a user to which the content item will be presented, geographic information associated with the request, and other information with which content item selection can be performed. The content item request can also specify a reserve price indicating a minimum bid that a winning bidder must have in order to provide a content item in response to the request. In some implementations, the content item request is an advertisement request requesting an advertisement to be provided with a resource. The content item request can be received, for example, from a user device or from another data processing apparatus that receives the content item request that was submitted by a user device.

Bids for eligible bidders are identified (304). In some implementations, the eligible bidders are those bidders that are identified as eligible to provide a content item in response to the content item request. As described above with reference to FIG. 2, a bidder can be identified as eligible to provide a content item in response to a content item request based, at least in part, on a bid for the bidder and/or distribution parameters that have been specified by the content item provider. For example, an eligible bidder can be required to have a bid that exceeds a reserve price that is associated with the content item request. Additionally, or alternatively, an eligible bidder can be required to have at least one content item for which one or more of the distribution parameters are matched by attributes specified by the content item request. The bids can be identified, for example, from a data store that stores bids for bidders.

A set of passback bidders that have been identified as eligible bidders are identified (306). As described above, passback bidders are bidders that are provided an option to refuse to provide a content item when selected as the winning bidder. The option to refuse to provide a content item is referred to as a passback capability. For example, as described with reference to FIG. 2, advertising network 1 120-1 utilizes the passback capability by providing response data 118-1 indicating that advertising network 1 120-1 will not be providing an advertisement for the advertisement request 202.

A highest general bidder is identified from the eligible bidders (308). As discussed above, a general bidder is a bidder that is not provided the option to refuse to provide a content item in response to a content item request. Thus, a general bidder can be a bidder for which the passback capability is not enabled. The highest general bidder can be a general bidder that provided a highest bid.

A bidder chain is created for the content item request (310). In some implementations, the bidder chain is created to include the highest general bidder and one or more of the passback bidders in the set of passback bidders. For example, as described above with reference to FIG. 2, the passback bidders that are included in the bidder chain can be those passback bidders having a bid that is higher than (or equal to) the bid for the highest general bidder.

The bidder chain includes one or more positions that are assigned to the bidders based on the bids for the bidders. As discussed above with reference to FIG. 2, the highest general bidder can be assigned to the lowest (or last) position in the bidder chain, and each of the passback bidders can be assigned positions that are higher than the position of the highest general bidder. For example, the passback bidder having a next higher bid relative to the bid for the highest general bidder can be assigned to a next higher position in the bidder chain. Other passback bidders can similarly be assigned to positions of the bidder chain based on their respective bids.

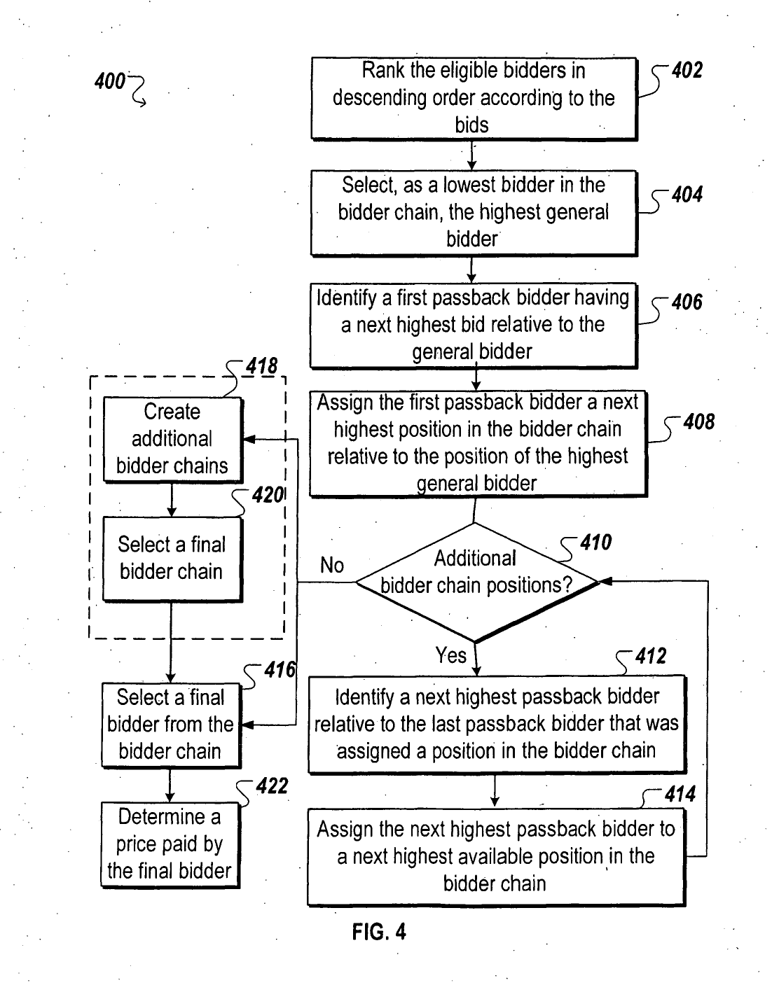

Alternatively, or additionally, a highest passback bidder can be first assigned to a highest (or first) position in the bidder chain, and each subsequent position in the bidder chain can be filled with a next highest passback bidder until the last position in the bidder chain is reached. Upon reaching the last position of the bidder chain, this last position will be assigned to the highest general bidder, such that the last bidder in the chain is a general bidder (or another non-passback bidder) rather than a passback bidder. An example process by which a bidder chain can be created is described below with reference to FIG. 4.

In some implementations, the bidder chain may include only one general bidder, and the general bidder can be assigned to a last position in the bidder chain. Since a general bidder has a fill rate of 1.0, any bidders that are included in chain positions that follow the chain position of the general bidder will not be provided an opportunity to provide a content item in response to the content item request. Therefore, the chain can be created to end with the single general bidder that is selected for inclusion in the chain.

In some situations, there may not be a general bidder that is selected for inclusion in the bidder chain. In these situations, the bidder chain can still be created, and may include a specified number of passback bidders having the highest bids. When a general bidder is not included in the bidder chain, the passback bidders in the chain can each decline the opportunity to provide a content item, such that it is possible that none of the bidders in the bidder chain provides a content item in response to an advertisement request. However, it can still be beneficial to create the bidder chain since there is at least some chance of one of the passback bidders agreeing to provide a content item in response to the content item request.

In some situations, it is possible that the general bidder is the only bidder included in the bidder chain. For example, the general bidder may have a highest bid among all bidders, or there may not be any passback bidders that are eligible to provide an advertisement in response to the advertisement request (e.g., no passback bidders with a bid higher than a reserve price for the content item request. In these situations, the bidder chain can be created to only include the general bidder.

A final bidder is selected from the bidder chain (312). In some implementations, the final bidder is the bidder that will provide a content item in response to the content item request. The final bidder can be, for example, a highest bidder in the bidder chain that does not refuse to provide a content item after being identified as the winning bidder.

For example, as described above with reference to FIG. 2, the bidder that has been assigned the highest (or first) position in the bidder chain (e.g., a bidder having a highest bid) will first be offered the opportunity to provide a content item in response to the content item request. If this bidder is a passback bidder that utilizes the passback capability, and thereby refuses to provide a content item in response to the content item request, the bidder that has been assigned the next highest position in the bidder chain will then be offered the opportunity to provide a content item in response to the content item request. The bidders in the bidder chain will continue to be sequentially offered the opportunity to provide a content item until a bidder agrees to provide a content item in response to the content item request. The bidder that agrees to provide a content item in response to the content item request is the final bidder.

FIG. 4 is a flow chart of an example process 400 for creating a bidder chain. The process 400 can be implemented, for example, using the advertising management system 110 of FIG. 1, or another data processing apparatus. The process 400 can also be implemented as instructions stored on computer storage medium such that execution of the instructions by data processing apparatus cause the data processing apparatus to perform the operations of the process 400.

The eligible bidders are ranked in descending order according to the bids (402). A highest ranked general bidder among the ranked bidders is selected as the lowest bidder in the bidder chain. For example, the highest general bidder can be assigned a position in the bidder chain at which all other bidders in the bidder chain will be offered an opportunity to provide a content item in response to a content item request prior to the highest general bidder being offered the opportunity to provide a content item in response to the content item request.

A first passback bidder having a next highest bid relative to the general bidder is identified (406). The first passback bidder is assigned to a next highest position in the bidder chain relative to the position of the highest general bidder. For example, the next highest position in the bidder chain can be assigned a position in the bidder chain at which all other bidders in the bidder chain, except for the highest general bidder, will be offered the opportunity to provide a content item in response to the content item request prior to the first passback bidder being offered the opportunity to provide a content item for the content item request.

A determination is made whether the bidder chain includes additional bidder chain positions that have not yet been assigned (410). In response to determining that additional bidder chain positions are available to be assigned, a next highest passback bidder is identified. The next highest passback bidder can be the passback bidder having a next highest bid relative to the bid for the first passback bidder.

The next highest passback bidder is assigned to the next highest position in the bidder chain (412). The next highest position in the bidder chain can be determined based on the position in the bidder chain that, was assigned to the last passback bidder to be assigned a position in the bidder chain.

The determination can again be made whether the bidder chain still includes additional positions that have yet to be assigned to bidders (410), and additional passback bidders can continue to be, assigned to available positions in the bidder chain until it is determined that the bidder chain does not include any available positions.

In some implementations, the determination can be made, for example, by identifying a pre-specified chain length that has been specified for the bidder chain, and determining that the pre-specified chain length will be exceeded if additional (or all of) the passback bidders having a bid higher than the highest general bidder are included in the bidder chain. The determination could be made after each passback bidder is assigned to a position in the bidder chain, prior to assigning any bidders to positions in the bidder chain, or at any other time.

In some implementations, when it is determined that there are no additional bidder chain positions available, the bidder chain that has been created can be used to select a final bidder (416), as described above with reference, to FIG. 2.

In some implementations, if there remain passback bidders that have a higher bid than the highest general bidder, but have not been assigned a position in the bidder chain, additional bidder chains can be created (418). For example, as described above with reference to FIG. 2, additional bidder chains (e.g., candidate chains) can be created such that each passback bidder having a bid that is higher than the bid for the highest general bidder is included in at least one of the additional bidder chains. In some implementations, every combination of the highest general bidder and the passback bidders having higher bids than the highest general bidder can be used to create a separate bidder chain.

A final bidder chain is selected from the additional bidder chains (420). In some implementations, the additional bidder chain having the highest chain value is selected as the final chain. For example, as described above with reference to FIG. 2, the chain value for each additional chain (e.g., candidate chain) can be determined based on the bids and fill rates for the bidders that are included in the bidder chain, and the chain having the highest chain value will be selected the final chain. The final chain is then used to select a final bidder (416), for example, in a manner similar to that described with reference to FIG. 2.

Once the final bidder has been selected, a price that the bidder will pay is determined (422). In some implementations, passback bidders (and or other bidders) pay a fixed price for each advertisement that they provide in response to advertisement requests. The price paid by a passback bidder can be, for example, equal to the bid for the passback bidder. For example, with reference to FIG. 2, if the passback bidder PB1 is selected as the final bidder, bidder PB1 will pay $5.00 for presentation of its advertisement.

In some implementations, bidders, such as general bidders, do not pay a fixed price for each advertisement that they provide, but rather pay a price that can vary on a per-request basis. In these implementations, the price paid by a general bidder (or other bidders that do not pay a fixed price) is based on a reference value and a chain value for a modified version of the final chain (a modified chain). The final chain is modified, for example, by removing the general bidder from the final chain. The reference value can be based on a reserve price associated with the content item request or a chain value for another bidder chain, referred to as an alternative chain. Determination of the price to be paid by a general bidder is described below with reference to FIG. 5.

FIG. 5 is a flow chart of an example process 500 for determining a price paid by a bidder in a passback auction. The process 500 can be implemented, for example, using the advertising management system 110 of FIG. 1, or another data processing apparatus. The process 500 can also be implemented as instructions stored on computer storage medium such that execution of the instructions, by data processing apparatus cause the data processing apparatus to perform the operations of the process 500.

FIG. 5 is described with reference to a general bidder that provided a content item, but the operations described with reference to FIG. 5 can be performed for any bidder that provides a content item.

The general bidder that provided the content item is removed from the bidder chain to create a modified chain (502). For example, if bidder GB1 is removed from the bidder chain 214 in FIG. 2, the resulting modified bidder chain will include only bidders PB1 and PB2.

A chain value is determined for the modified chain (504). The chain value for the modified chain can be computed in a manner similar to that described above with reference to FIG. 2. For example, using relationship (1) and relationship (2) above, the chain value can be computed as a sum of the values of the bidders to the modified chain. In the present example, the chain value for the modified chain can be $4.16 by summing the value of PB1 to the modified chain, which is $2.00 (i.e., $2.00=0.4 (PB1 fill rate)*$5.00 (PB1 bid), and the value of PB2 to the modified chain, which is $2.16 (i.e., $2.16=0.6 (1-PB1 fill rate)*0.4 (PB2 fill rate)*$4.00 (PB2 bid).

A reference value is identified based on one of a reserve price or a chain value for an alternative chain that differs from the modified chain (506). An alternative chain is a bidder chain that includes one or more of the eligible bidders, but does not include the general bidder (or another bidder) that was selected as the final winning bidder (e.g., the bidder that agreed to provide a content item in response to a content item request). One or more alternative chains can be created in a manner similar to that described with reference to FIG. 2 using only those eligible bidders that were not the final winning bidder.

In some implementations, a chain length of the alternative chain can be limited to the chain length of the modified chain. For example, when GB1 is removed from the bidder chain 214 in FIG. 2, the chain length of the modified chain will be two. In this example, the maximum chain length for an alternative chain could be set to two, such that an alternative chain could include at most two of the eligible bidders for the content item request.

The reference value can be identified as the maximum value from among a highest chain value for the alternative chains and a reserve price, if one has been specified for the content item request. For example, assume that the reserve price that must be paid by a content item provider for providing a content item in response to the content item request is $2.00. In this example, if the highest chain value for one of the alternative chains is $6.00, then the reference value will be set to $6.00.

Once the reference value has been identified, the price to be paid by the general bidder can be determined based on a function of the chain value for the modified chain and the reference value. In some implementations, the price to be paid by the general bidder is determined using relationship (3)

$${Price}_{S} = \frac{{V}_{Ref} - {V}_{ModChain}}{{P}_{WB} ( 3 )}$$

where:

Price_{B} is the price to be paid by the bidder;

V_{Ref} is the reference value;

V_{ModChain} is the chain value for the modified chain; and

P_{WB} is the probability that the bidder is selected as the final winning bidder.

P_{WB} can be determined, for example, based on the likelihood that each bidder that has been assigned a higher position in the bidder chain than the general bidder refuses to provide a content item in response to the content item request. For example, if general bidder GB has been assigned a third position in the bidder chain, the likelihood that the GB will be selected as the final winning bidder can be determined as the result of (1−FRb₁)*(1−FRb₂), where FRb₁ is the fill rate for the bidder that was assigned the first position in the bid chain, and FRb₂ is the fill rate for the bidder that was assigned to the second position in the bidder chain.

In some implementations, a general bidder (or another bidder) may specify a minimum price that they will pay for each presentation of a content item. If such a minimum price has been specified, the general bidder will pay the greater of the minimum price and the price determined in the manner described in the preceding paragraphs. For example, assume that the general bidder has agreed to pay at least $4.00 and that that price determined using relationship (3) above is $3.50. In this example, the general bidder will pay the $4.00 minimum price rather than the $3.50 price.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method performed by data processing apparatus, the method comprising:
receiving a content item request;
identifying, by a data processing apparatus, bids for a plurality of eligible bidders that are eligible to provide a content item in response to the content item request;
identifying, among the eligible bidders, a set of passback bidders for which a passback capability is enabled, wherein the passback capability provides passback bidders an option refuse to provide a content item after selection of a winning bidder;
identifying, among the bidders, a set of general bidders for which the passback capability is not enabled;
creating, by a data processing apparatus, a bidder chain that includes a highest general bidder and one or more passback bidders having higher bids than the highest general bidder, each bidder being assigned a position in the bidder chain based on their respective bids; and
selecting, from the bidder chain and by a data processing apparatus, a final bidder that will provide a content item in response to the content item request, the final bidder being a highest bidder in the bidder chain that does not refuse to provide a content item after being identified as the winning bidder.

2. The method of claim 1, wherein creating the bidder chain comprises:
selecting, as a lowest bidder in the bidder chain, the highest general bidder;
ranking the set of passback bidders based on the bids for the passback bidders;
identifying a first passback bidder having a next highest bid relative to the highest general bidder; and
assigning the first passback bidder a next highest position in the bidder chain, the next highest position being identified relative to a position of the highest general bidder in the bidder chain.

3. The method of claim 1, wherein creating a bidder chain comprises:
identifying a pre-specified chain length for the bidder chain, the pre-specified chain length indicating a number of bidders to be included in the chain;
determining that the pre-specified chain length will be exceeded by including, in the bidder chain, all of the passback bidders having a bid higher than the highest general bidder;
creating a first candidate bidder chain that includes the highest general bidder and a first passback bidder having a next highest bid relative to the highest general bidder;
creating a second candidate bidder chain that includes the highest general bidder and a second passback bidder having a bid higher than the first passback bidder, but does not include the first passback bidder; and
selecting the bidder chain from among the first candidate bidder chain and the second candidate bidder chain.

4. The method of claim 3, wherein selecting the bidder chain comprises:
identifying fill rates for the passback bidders, the fill rate for each passback bidder specifying a rate with which the passback bidder has refused to provide a content item after being selected as the winning bidder;
determining a chain value for the first candidate bidder chain, the chain value being determined based on the bids for bidders in the first candidate bidder chain and the fill rate for each passback bidder in the first candidate bidder chain;
determining the chain value for the second candidate bidder chain, the chain value for the second candidate bidder chain being determined based on the bids for bidders in the second candidate bidder chain and the fill rate for each passback bidder in the second candidate bidder chain; and
selecting one of the first candidate bidder chain or the second candidate bidder chain as the bidder chain, the selected bidder chain having a highest chain value.

5. The method of claim 4, further comprising determining a price for the final bidder, the determination including:
removing the final bidder from the bidder chain to create a modified chain;
determining a first chain value for the modified chain, the first chain value being determined based on the bids for bidders in the modified chain and the fill rate for each passback bidder in the modified chain;
identifying an alternative chain that includes a different set of bidders than the modified chain and does not include the final bidder;
determining a second chain value for the alternative chain, the second chain value being determined based on the bids for bidders in the alternative chain and the fill rate for each passback bidder in the alternate bidder chain; and
determining the price based on a difference between the first chain value and the second chain value.

6. The method of claim 4, further comprising determining a price for the final bidder, the determination including:
removing the final bidder from the bidder chain to create a first alternative chain;
determining a first chain value, for the first alternative chain, the first chain value being determined based on the bids for bidders in the first alternative chain and the fill rate for each passback bidder in the first candidate bidder chain;
identifying a reserve price that must be paid for providing a content item in response to the content item request; and
determining the price based on a difference between the first chain value and the reserve price.

7. A computer storage medium encoded with a computer program, the program comprising instructions that when executed by data processing apparatus cause the data processing apparatus to perform operations comprising:
receiving a content item request;
identifying bids for a plurality of eligible bidders that are eligible to provide a content item in response to the content item request;
identifying, among the eligible bidders, a set of passback bidders for which a passback capability is enabled, wherein the passback capability provides passback bidders an option refuse to provide a content item after selection of a winning bidder;
identifying, among the bidders, a set of general bidders for which the passback capability is not enabled;
creating a bidder chain that includes a highest general bidder and one or more passback bidders having higher bids than the highest general bidder, each bidder being assigned a position in the bidder chain based on their respective bids; and
selecting, from the bidder chain, a final bidder that will provide a content item in response to the content item request, the final bidder being a highest bidder in the bidder chain that does not refuse to provide a content item after being identified as the winning bidder.

8. The computer storage medium of claim 7, wherein creating the bidder chain comprises:
selecting, as a lowest bidder in the bidder chain, the highest general bidder;
ranking the set of passback bidders based on the bids for the passback bidders;
identifying a first passback bidder having a next highest bid relative to the highest general bidder; and
assigning the first passback bidder a next highest position in the bidder chain, the next highest position being identified relative to a position of the highest general bidder in the bidder chain.

9. The computer storage medium of claim 7, wherein creating a bidder chain comprises:
identifying a pre-specified chain length for the bidder chain, the pre-specified chain length indicating a number of bidders to be included in the chain;
determining that the pre-specified chain length will be exceeded by including, in the bidder chain, all of the passback bidders having a bid higher than the highest general bidder;
creating a first candidate bidder chain that includes the highest general bidder and a first passback bidder having a next highest bid relative to the highest general bidder;
creating a second candidate bidder chain that includes the highest general bidder and a second passback bidder having a bid higher than the first passback bidder, but does not include the first passback bidder; and
selecting the bidder chain from among the first candidate bidder chain and the second candidate bidder chain.

10. The computer storage medium of claim 9, wherein selecting the bidder chain comprises:
identifying fill rates for the passback bidders, the fill rate for each passback bidder specifying a rate with which the passback bidder has refused to provide a content item after being selected as the winning bidder;
determining a chain value for the first candidate bidder chain, the chain value being determined based on the bids for bidders in the first candidate bidder chain and the fill rate for each passback bidder in the first candidate bidder chain;
determining the chain value for the second candidate bidder chain, the chain value for the second candidate bidder chain being determined based on the bids for bidders in the second candidate bidder chain and the fill rate for each passback bidder in the second candidate bidder chain; and
selecting one of the first candidate bidder chain or the second candidate bidder chain as the bidder chain, the selected bidder chain having a highest chain value.

11. The computer storage medium of claim 10, wherein the instructions further cause the data processing apparatus to perform operations comprising determining a price for the final bidder, the determination including:
removing the final bidder from the bidder, chain to create a modified chain;
determining a first chain value for the modified chain, the first chain value being determined based on the bids for bidders in the modified chain and the fill rate for each passback bidder in the modified chain;
identifying an alternative chain that includes a different set of bidders than the modified chain and does not include the final bidder;
determining a second chain value for the alternative chain, the second chain value being determined based on the bids for bidders in the alternative chain and the fill rate for each passback bidder in the alternate bidder chain; and
determining the price based on a difference between the first chain value and the second chain value.

12. The computer storage medium of claim 10, wherein the instructions further cause the data processing apparatus to perform operations comprising determining a price for the final bidder, the determination including:
removing the final bidder from the bidder chain to create a first alternative chain;
determining a first chain value for the first alternative chain, the first chain value being determined based on the bids for bidders in the first alternative chain and the fill rate for each passback bidder in the first candidate bidder chain;
identifying a reserve price that must be paid for providing a content item in response to the content item request; and
determining the price based on a difference between the first chain value and the reserve price.

13. A system comprising:
a data store storing bids for bidders;
one or more computers that interact with the data store, the one or more computers including instructions that upon execution cause the one or more computers to perform operations comprising:
receiving a content item request;
identifying bids for a plurality of eligible bidders that are eligible to provide a content item in response to the content item request;
identifying, among the eligible bidders, a set of passback bidders for which a passback capability is enabled, wherein the passback capability provides passback bidders an option refuse to provide a content item after selection of a winning bidder;
identifying, among the bidders, a set of general bidders for which the passback capability is not enabled;
creating a bidder chain that includes a highest general bidder and one or more passback bidders having higher bids than the highest general bidder, each bidder being assigned a position in the bidder chain based on their respective bids; and
selecting, from the bidder chain, a final bidder that will provide a content item in response to the content item request, the final bidder being a highest bidder in the bidder chain that does not refuse to provide a content item after being identified as the winning bidder.

14. The system of claim 13, wherein the one or more computers create the bidder chain by performing operations comprising:
selecting, as a lowest bidder in the bidder chain, the highest general bidder;
ranking the set of passback bidders based on the bids for the passback bidders;
identifying a first passback bidder having a next highest bid relative to the highest general bidder; and
assigning the first passback bidder a next highest position in the bidder chain, the next highest position being identified relative to a position of the highest general bidder in the bidder chain.

15. The system of claim 13, wherein the one or more computers create the bidder chain by performing operations comprising:
identifying a pre-specified chain length for the bidder chain, the pre-specified chain length indicating a number of bidders to be included in the chain;
determining that the pre-specified chain length will be exceeded by including, in the bidder chain, all of the passback bidders having a bid higher than the highest general bidder;
creating a first candidate bidder chain that includes the highest general bidder and a first passback bidder having a next highest bid relative to the highest general bidder;
creating a second candidate bidder chain that includes the highest general bidder and a second passback bidder having a bid higher than the first passback bidder, but does not include the first passback bidder; and
selecting the bidder chain from among the first candidate bidder chain and the second candidate bidder chain.

16. The system of claim 15, wherein the one or more computers select the bidder chain by performing operations comprising:
identifying fill rates for the passback bidders, the fill rate for each passback bidder specifying a rate with which the passback bidder has refused to provide a content item after being selected as the winning bidder;
determining a chain value for the first candidate bidder chain, the chain value being determined based on the bids for bidders in the first candidate bidder chain and the fill rate for each passback bidder in the first candidate bidder chain;
determining the chain value for the second candidate bidder chain, the chain value for the second candidate bidder chain being determined based on the bids for bidders in the second candidate bidder chain and the fill rate for each passback bidder in the second candidate bidder chain; and
selecting one of the first candidate bidder chain or the second candidate bidder chain as the bidder chain, the selected bidder chain having a highest chain value.

17. The system of claim 16, wherein the instructions further cause the one or more computers to perform operations comprising determining a price for the final bidder, the determination including:
removing the final bidder from the bidder chain to create a modified chain;
determining a first chain value for the modified chain, the first chain value being determined based on the bids for bidders in the modified chain and the fill rate for each passback bidder in the modified chain;
identifying an alternative chain that includes a different set of bidders than the modified chain and does not include the final bidder;
determining a second chain value for the alternative chain, the second chain value being determined based on the bids for bidders in the alternative chain and the fill rate for each passback bidder in the alternate bidder chain; and
determining the price based on a difference between the first chain value and the second chain value.

18. The system of claim 16, wherein the instructions further cause the one or more computers to perform operations comprising determining a price for the final bidder, the determination including:
removing the final bidder from the bidder chain to create a first alternative chain;
determining a first chain value for the first alternative chain, the first chain value being determined based on the bids for bidders in the first alternative chain and the fill rate for each passback bidder in the first candidate bidder chain;
identifying a reserve price that must be paid for providing a content item in response to the content item request; and
determining the price based on a difference between the first chain value and the reserve price.
